(19) United States
(12) Patent Application Publication
(10) Pub. No.: US 2024/0143814 A1
(43) Pub. Date: May 2, 2024

(54) DYNAMIC AND SECURE ACCESS TO UEFI SERVICES BASED ON INDICATOR OF ATTACK DRIVER

(71) Applicant: Dell Products L.P., Round Rock, TX (US)

(72) Inventors: Sumanth VIDYADHARA, Bangalore (IN); Karunakar POOSAPALLI, Medak (IN)

(73) Assignee: Dell Products L.P., Round Rock, TX (US)

(21) Appl. No.: 17/975,644

(22) Filed: Oct. 28, 2022

(51) Int. Cl. G06F 21/62; G06F 21/44; G06F 21/57

(52) U.S. Cl. CPC G06F 21/6218; G06F 21/44; G06F 21/575; G06F 2221/034

(57) ABSTRACT

Disclosed subject matter enables a recovery and resume of secure platform services based on indicator of attack for the UEFI boot path and UEFI drivers for any access to storage or network medium. Disclosed methods may employ an unsupervised learning model, based on information referred to herein as Indicator of Attack (IOA) information, and create a unique resilient BIOS access for UEFI drivers, file system, media and network. Disclosed teachings enable secure services for access to UEFI drivers, file systems, media, and network using a dynamic resilient layer to handle IOA. Dynamic methods to create runtime metadata for file system logical blocks for OEM nested file system partition and pre boot OEM authentication are also disclosed. Disclosed teachings support a UEFI file system interface that implements a runtime remap method for OEM-provided drivers.

### TECHNICAL FIELD

The present disclosure relates to information handling system security and, more particularly, detecting and responding to system vulnerabilities to preserve a secure and reliable platform.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Generally, information handling systems have vulnerabilities that render them susceptible to being compromised by unauthorized modifications of system software and firmware. Accordingly, ensuring a stable and trustworthy system is a fundamental requirement for information handling system manufacturers and distributors, referred to herein as original equipment manufacturers (OEMs) including, without limitation, Dell Technologies. However, OEMs face numerous challenges to fulfilling this requirement.

Many information handling systems support and/or comply with the Universal Extensible Firmware Interface (UEFI) specification defining an interface between platform firmware and an operating system (OS). UEFI encompasses a Platform Initialization (PI) specification that defines core code and services required for an implementation of the Pre-EFI Initialization (PEI) phase of the PI architecture. The PEI phase, which is invoked early in the boot sequence following a machine restart, dispatches PEI Modules (PIEMs) that, in part, initialize some permanent memory, describe the memory and firmware volume locations in Hand-Off Blocks (HOBs), and pass control to the Driver Execution Environment (DXE) phase. The PEI phase is also responsible for crisis recovery and resuming from an S3 sleep state.

PEIMs communicate with each other using a PEIM-to-PEIM Interface (PPI). PPIs are inventoried in a data structure containing (GUID, pointer) pairs. The GUID “names” the interface and the associated pointer provides the associated data structure and/or service set for that PPI.

UEFI core services may have security issues that make them potentially vulnerable. As an example, a hacker can find the GUID values for one or more PPIs and register a notify call for a core module or OEM-provided feature. When the PPI is installed, the vulnerable caller or module may get control of the pre-boot environment and have access to all OEM provided features and data in NVMe and other storage resources.

Information handling systems employ device drivers to support functionality for various system components and such drivers may be loaded as part of a boot sequence. A driver may support various options and a platform may support volatile settings for one or more of these options, enabling a user to activate and deactivate the applicable option without rebooting. Volatile driver options may expose a system vulnerability enabling, as an example, an unauthorized basic input/output system (BIOS) driver or external component to create a new driver option and include it in a serial peripheral interface (SPI) store, via this nonvolatile variable. A module or driver stored in an external nonvolatile memory express (NVMe) or Universal Serial Bus (USB) store can create a driver option with device path node and file path of the external store and create a new driver option to the SPI store.

An information handling system platform may be provisioned with a secure boot BIOS to prevent a root kit from being installed. An OEM may configure its secure boot BIOS with different modes to support desired functionality. For example, an audit mode may enable a system to execute and log secure boot cryptographic checks without applying the results. However, an untrusted shell application may be able to launch and add a KEY key to the database to generate a signed EFI, that can even launch SecureBoot-Deploy mode. Although a BIOS admin mode can be used to address this concern, a customer may not set BIOS admin password.

### SUMMARY

Disclosed teachings enable a recovery and resume of secure platform services based on indicator of attack for the UEFI boot path and UEFI drivers for any access to storage or network medium. Disclosed methods may employ an unsupervised learning model, based on information referred to herein as Indicator of Attack (IOA) information, and create a unique resilient BIOS access for UEFI drivers, file system, media and network. Disclosed teachings enable secure services for access to UEFI drivers, file systems, media, and network using a dynamic resilient layer to handle IOA. Dynamic methods to create runtime metadata for file system logical blocks for OEM nested file system partition and pre boot OEM authentication are also disclosed. Disclosed teachings support a UEFI file system interface that implements a runtime remap method for OEM-provided drivers. Also disclosed is a method to create protected UEFI PPI or protocol identifiers for secured and vulnerable-free pre boot UEFI drivers for any access to storage or network media.

Subject matter set forth herein discloses an IOA driver solution that is triggered when any pre-boot or runtime module attempts to locate file system protocol. The disclosed IOA driver will attempt to authenticate the module and, if the module is authenticated as a trusted UEFI driver, the protocol then it grants the module access to metadata and OEM file system handles that represent the file or directory on the user's system. Exemplary submodules suitable to implement complete secure platform services are discussed below.

An OEM-associated Indicator of Attack (IOA) method to Access or Block System: This feature implements a disclosed IOA driver to detect pre-boot or runtime modules that try to locate a file system protocol. Detection triggers the IOA driver to authenticate the module and, if it is a trusted driver, then access to metadata and OEM file system handles is granted. If the module is a runtime application or UEFI shell application, the IOA driver will not expose the file system handles to external driver and will prevent data access.

Secured transition band for UEFI core Agents and system Access and OEM Authenticated Driver Order: This method implements a secured transition layer to validate and authenticate UEFI core registration for PPI or protocol interface callbacks and restrict the services for unauthorized driver operations outside BIOS components. This prevents loading unauthorized external drivers or modulus as part of SPI and avoid malware data modifications for any of the OEM certificates, SPI content, vendor keys, NV store data and OEM flags. This method also implements a solution for validating device path of any data access/writes calls using UEFI Device path protocol. It may parse the device path of the caller and identify whether the driver is from pre-boot PEI, DXE or SMM drivers or outside BIOS modules.

Method to create protected GUID based mapping for UEFI core Service and OEM System: This solution provides a method secured GUID data for file system access and driver order variable interface. This method creates a mapping table for unique identifier for PPI or protocol services in pre-boot. This solution also provides mechanism to store the identifiers to OEM specific declaration files. UEFI identifiers for different PPI or protocol will be remapped to OEM unique identifiers which are exposed to OEM drivers and if any other PEI or runtime drivers wants to retrieve core interfaces, this method will pass through OEM authentication layer and provide vulnerable free and protected data access. OEM protected identifiers and variables GUIDs are not exposed to pre-boot drivers. The interfaces will be located and access using OEM secured transition layer.

Dynamic method to create runtime Metadata for File system Logical blocks for OEM Nested File System Partition. This feature implements a method to create nested or hidden partition for simple file protocol in UEFI BIOS. This solution implements a new pre-boot module OemNestedFileSysDxeSmm, that implements a runtime method to locate core system protocol services and remap to OEM provided drivers. This feature will remap and hidden with OEM specific GUID which is stored in OEM NV store. Once mapping is done it creates a metadata with offset and file read or write interface services. This provides a secured communication access to OEM features and other runtime modules. This metadata can be shared to authenticated BIOS modules or drivers. This provides a mechanism such that each driver will have its own file system with minimal metadata by consuming the metadata from OemNestedFileSysDxeSmm driver.

Secured transition band for UEFI core agents and system access and OEM-Authenticated Driver Order: This feature implements a secured transition layer to validate and authenticate UEFI core registration for PPI or protocol interface callback and restricts the services to unauthorized driver operations outside BIOS components. This prevents loading unauthorized external drivers or modulus as part of boot sequence and avoids malware data modifications for any of the OEM certificates, SPI content, vendor keys, NV store data and OEM flags. This feature also implements a solution for validating device path of any data access/writes calls using UEFI device path protocol. It parses the device path of the caller and identify whether the driver is from pre boot PEI, DXE or SMM drivers or outside BIOS modules. Based on created device path, if the caller is outside BIOS, this method implements failover mechanism or rollback to original values.

OEMTrustedRegNotifyPeiDxe module. This driver creates a secured layer to provide a mechanism for authenticating a caller. When any caller tries to retrieve or modify OEM flags or data, this driver will validate the input parameters and authenticate the caller with method described below.

Driver will obtain caller details using EFI COMPONENT NAME2 PROTOCOL to retrieve the caller driver or controller name.

Once Driver name is parsed, the device path of called driver or module is obtained. Based on device path and its nodes, drive will validate the device with node types.

When the device node of the caller is not part of BIOS drivers, this method will return as invalid or unsupported driver. Most of the BIOS drivers like DXE, SMM or ACPI callbacks the device path will be like Media device path or ACPI device path etc.

If the device node type of calling driver is USB type and some other storage devices that mean the caller is from UEFI shell application or any other media.

Driver will reject the non authenticated get variables calls and return unknown device to prevent unknown drivers from read port data. If the caller is from an authenticated driver it, calls to read and write native services are permitted to get or set data and publish to caller. When this driver returns with a fails as unauthenticated module or driver, it internally calls OEM secured authenticated callback to prevent creating/accessing UEFI core services.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIGS. 1 and 2 illustrate aspects of a secured transition band for UEFI core agents in accordance with disclosed teachings;

FIG. 3 illustrates a method to create protected GUID-based mapping for UEFI core services; and

FIGS. 4 and 5 illustrate a dynamic method to create runtime metadata for file system logical blocks for OEM nested file system partitions; and

FIG. 6 illustrates an exemplary information handling system suitable for use in conjunction with subject matter disclosed in FIG. 1 through FIG. 5.

### DETAILED DESCRIPTION

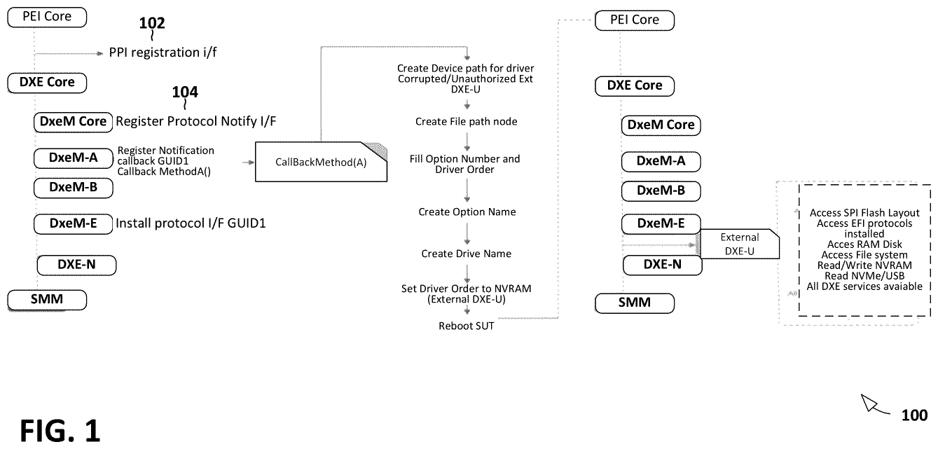

Exemplary embodiments and their advantages are best understood by reference to FIGS. 1-6 wherein like numbers are used to indicate like and corresponding parts unless expressly indicated otherwise.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”), microcontroller, or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

Additionally, an information handling system may include firmware for controlling and/or communicating with, for example, hard drives, network circuitry, memory devices, I/O devices, and other peripheral devices. For example, the hypervisor and/or other components may comprise firmware. As used in this disclosure, firmware includes software embedded in an information handling system component used to perform predefined tasks. Firmware is commonly stored in non-volatile memory, or memory that does not lose stored data upon the loss of power. In certain embodiments, firmware associated with an information handling system component is stored in non-volatile memory that is accessible to one or more information handling system components. In the same or alternative embodiments, firmware associated with an information handling system component is stored in non-volatile memory that is dedicated to and comprises part of that component.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems (BIOSs), buses, memories, I/O devices and/or interfaces, storage resources, network interfaces, motherboards, and/or any other components and/or elements of an information handling system.

In the following description, details are set forth by way of example to facilitate discussion of the disclosed subject matter. It should be apparent to a person of ordinary skill in the field, however, that the disclosed embodiments are exemplary and not exhaustive of all possible embodiments.

Throughout this disclosure, a hyphenated form of a reference numeral refers to a specific instance of an element and the un-hyphenated form of the reference numeral refers to the element generically. Thus, for example, “device 12-1” refers to an instance of a device class, which may be referred to collectively as “devices 12” and any one of which may be referred to generically as “a device 12”.

As used herein, when two or more elements are referred to as “coupled” to one another, such term indicates that such two or more elements are in electronic communication, mechanical communication, including thermal and fluidic communication, thermal, communication or mechanical communication, as applicable, whether connected indirectly or directly, with or without intervening elements.

FIG. 1 illustrates a secured transition band method 100 for UEFI core agents, system access, and OEM authenticated driver order. The method 100 illustrated in FIG. 1 may implement an OEM driver and invoke a dispatcher at early PEI phase, DXE boot phase, and enable. The method may also implement secured transition solution for DXE and runtime modules.

An early PEI driver may enable (at 102) transition layer for EFI core register PEI notifications. Once the DXE dispatcher and core services are created, an early DXE driver will override (at 104) the core interfaces register protocol notifications.

UEFI BIOS has a core interface register PPI/Protocol flow as illustrated in FIG. 1. Pre boot PEI or DXE/SMM drivers can register for any protocol or PPI installed by any of core module or OEM module or even any feature driver installing PPI.

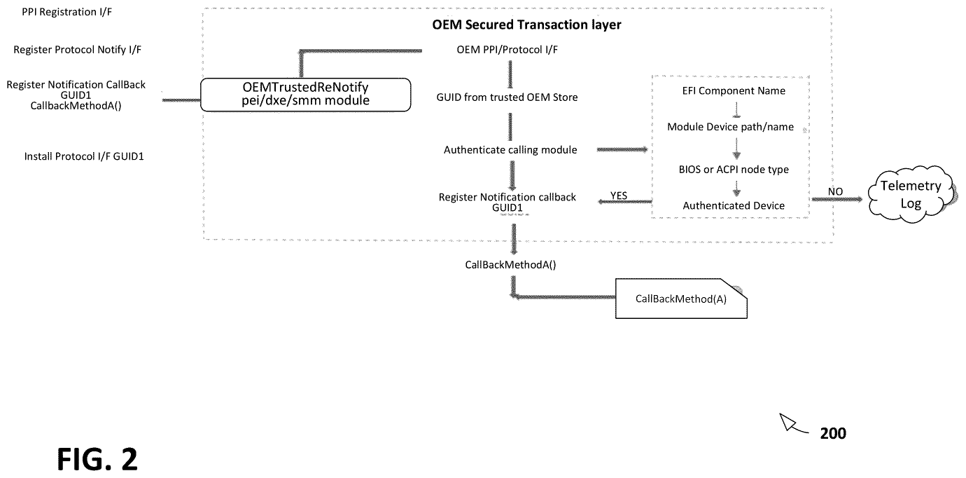

Referring now to FIG. 2, additional features 200 of an OEM secured transition layer are illustrated. In post, if any pre boot or runtime drivers requests to register any PPI or protocol nonfictions and callbacks, OEMTrustedRegNotifyPeiDxeSmm will get the override call and this driver will provide the services to create a device path for I/O or hardware access callers or modules and provides the functions to check whether the caller is from BIOS driver or any UEFI application or pre boot applications. If the data modification caller is outside BIOS, this driver restricts the access and prevents loading unauthorized external drivers or modulus. This method implements OEM driver and makes the dispatch early PEI and DXE boot phase and enable. The illustrated method also implements secured transition solution for DXE and runtime drivers. The OEM override secured layer for core interfaces and agents for PEIM, DXE and runtime modules. Early PEI driver will enable transition layer for EFI core register PEI notifications. Once the DXE dispatcher and core services are created, early DXE driver will override the core interfaces register protocol notifications. When the secured layer finds the device error or detects untrusted device, it shares the error log with device details to BIOS event log and telemetry log.

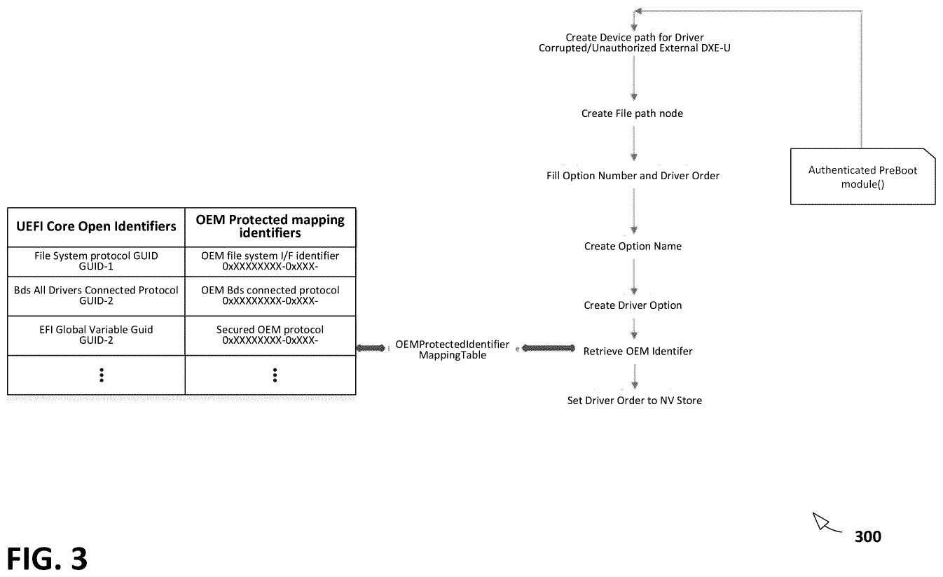

FIG. 3 illustrates a method 300 to create protected GUID based mapping for UEFI core Service and OEM System: The depicted solution provides a method secured GUID data for file system access and driver order variable interface. This method creates a mapping table for unique identifier for PPI or protocol services in pre boot. This solution also provides mechanism to store the identifiers to OEM specific declaration files.

UEFI identifiers for different PPI or protocol will be remapped to OEM unique identifiers which are exposed to OEM drivers and if any other PEI or runtime drivers wants to retrieve core interfaces, this method will pass through OEM authentication layer and provide vulnerable free and protected data access.

OEM protected identifiers and variables GUIDs won't be exposed to all pre boot drivers. And this interfaces will be located and access using OEM secured transition layer.

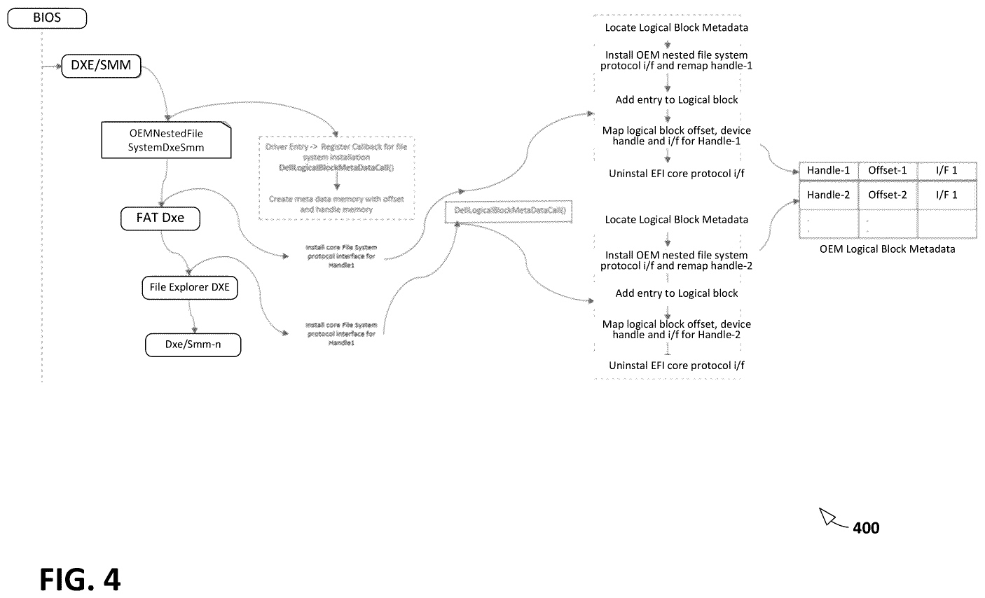

FIG. 4 illustrates an exemplary dynamic method 400 to create runtime Metadata for File system Logical blocks for OEM Nested File System Partition: This solution implements method to create nested or hidden partition for simple file protocol in UEFI bios. This solution implements a new pre boot module OEMAuthNestedFileSysteDxeSmm, which implement runtime method to locate core system protocol services and remap to OEM provided drivers. This Driver will remap and hidden with OEM specific GUID which is stored in OEM NV store and once mapping is done it creates a metadata with offset and file read or write interface services. This provides a secured communication access to OEM features and other runtime modules. This metadata can be shared to authenticated bios modules or drivers. This provides a mechanism such that each driver will have its own file system with minimal metadata by consuming the metadata from OEMNestedFileSysteDxeSmm driver OEMNestedFileSysteDxeSmm will consume the OEM unique identifier data and create a callback method for install PPI or protocol interface and whenever any PEI or DXE module calls install interface then this callback will get control and override.

This solution also provides method to enumerate and load minimal file system protocol interface and creates a runtime handler to enumerate and load all file systems handles in system on demand.

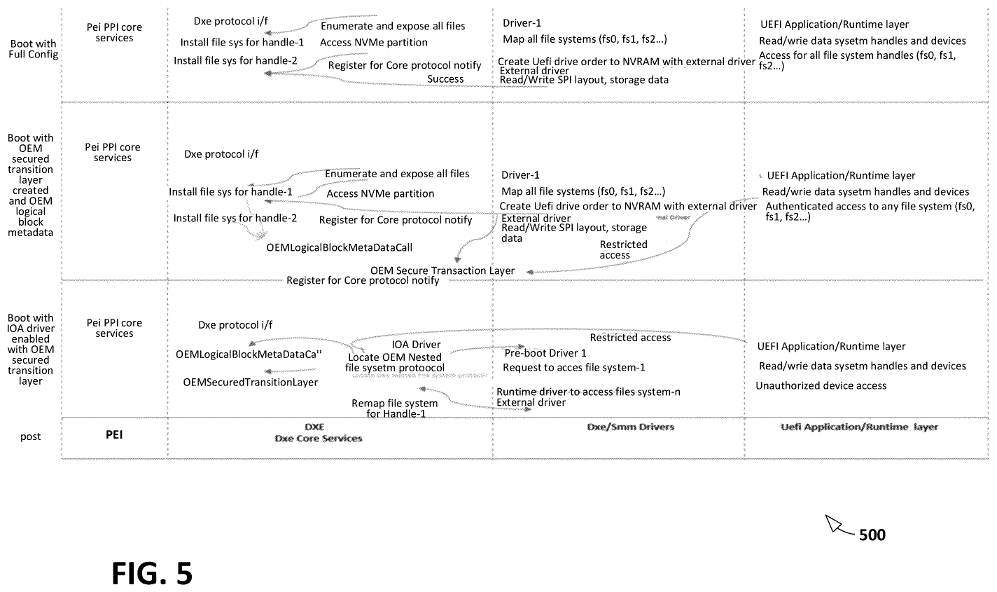

FIG. 5 illustrates features of an exemplary OEM associated Indicator of Attack (IOA) method 500 to Access or Block System: This method implements IOA driver solution, When any of the pre boot or runtime modules try to locate file system protocol, IOA driver will get trigger and authenticate the driver if its trusted SPI driver then it gives the access to meta data and OEM file system handle. If the driver is runtime application or UEFI shell application IOA will not expose the file system handles to external driver and prevent the data access.

This solution also provides method to enumerate and load minimal file system protocol interface and creates a runtime handler to enumerate and load all file systems handles in system on demand.

When pre boot SPI driver tries to locate EFI core protocol OEM IOA driver callback will get triggered and locates the logical block meta data and finds the mapped handle and protocol interface.

With OEM remapped protocol interface driver will get minimal file system information and access the storage device. Once the driver is authorized by OEM secured transition layer, The driver will share meta data to find the offset, handle and protocol interface.

Any runtime driver or UEFI app is locating and accessing the file system installed, then OEMTrustedRegNotifyPeiDxe will authenticate the driver and pass-through secured layer. When the layer restricts as untrusted device and restricts the protocol interface access. This method also logs an error methods to OEM bios events log and telemetry log.

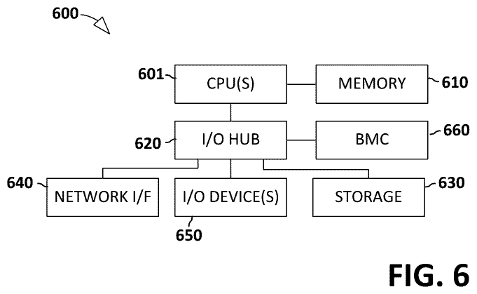

Referring now to FIG. 6, any one or more of the elements illustrated in FIG. 1 through FIG. 5 may be implemented as or within an information handling system exemplified by the information handling system 600 illustrated in FIG. 6. The illustrated information handling system includes one or more general purpose processors or central processing units (CPUs) 601 communicatively coupled to a memory resource 610 and to an input/output hub 620 to which various I/O resources and/or components are communicatively coupled. The I/O resources explicitly depicted in FIG. 6 include a network interface 640, commonly referred to as a NIC (network interface card), storage resources 630, and additional I/O devices, components, or resources 650 including as non-limiting examples, keyboards, mice, displays, printers, speakers, microphones, etc. The illustrated information handling system 600 includes a baseboard management controller (BMC) 660 providing, among other features and services, an out-of-band management resource which may be coupled to a management server (not depicted). In at least some embodiments, BMC 660 may manage information handling system 600 even when information handling system 600 is powered off or powered to a standby state. BMC 660 may include a processor, memory, an out-of-band network interface separate from and physically isolated from an in-band network interface of information handling system 600, and/or other embedded information handling resources. In certain embodiments, BMC 660 may include or may be an integral part of a remote access controller (e.g., a Dell Remote Access Controller or Integrated Dell Remote Access Controller) or a chassis management controller.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

What is claimed is:

1. A method comprising:
provisioning an information handling system with one or more secure platform modules (SPMs), wherein the one or more SPMs include:
a first SPM comprising an indicator of attack (IOA) driver configured to perform operations including:
responsive to detecting either a runtime module or a preboot module attempting to locate a file system protocol, authenticating the caller;
responsive to successfully authenticating the module as a trusted driver, granting access to OEM meta data and a file system handle; and
responsive to determining that the module is a runtime application or a UEFI shell application, denying access to the OEM meta data and file system handle.

2. The method of claim 1, wherein the one or more SPMs include:
a second SPM configured to perform secured transition band operations, wherein the secured transition band operations include:
validating and authenticating UEFI core registration for PHY Protocol Interface (PPI) or protocol interface callback services; and
validating a device path of a data access call using UEFI device path protocol.

3. The method of claim 2, wherein said validating of the device path includes:
parsing a device path of the caller; and
determining whether the caller is from preboot, PEI, DXE, or SMM drivers.
de BIOS modules.

4. The method of claim 2, wherein the SPMs include a third SPM comprising a secured GUID data method configured to:
create a GUID based mapping table for unique identifier for PPI or protocol services in pre boot;
store the identifiers to OEM specific declaration files;
remap UEFI identifiers for different PPI or protocol to OEM-unique identifiers, which are exposed to OEM drivers;
responsive to any other PEI or runtime drivers attempting to access core interfaces, passing through OEM authentication layer and providing vulnerable free and protected data access.

5. The method of claim 4, wherein the SPMs include a fourth SPM configured to create runtime meta data for file system logical blocks for a nested file system partition;
locate core system protocol services;
remap the core system protocol services to OEM-provided drivers; and
create meta data with offset and file read or write interface services.

6. The method of claim 1, wherein the SPMs include a third SPM comprising a secured GUID data method configured to:
create a GUID based mapping table for unique identifier for PPI or protocol services in pre boot;
store the identifiers to OEM specific declaration files;
remap UEFI identifiers for different PPI or protocol to OEM-unique identifiers, which are exposed to OEM drivers;
responsive to any other PEI or runtime drivers attempting to access core interfaces, passing through OEM authentication layer and providing vulnerable free and protected data access.

7. The method of claim 6, wherein the SPMs include a fourth SPM configured to create runtime meta data for file system logical blocks for a nested file system partition;
locate core system protocol services;
remap the core system protocol services to OEM-provided drivers; and
create meta data with offset and file read or write interface services.

8. The method of claim 1, wherein the SPMs include a fourth SPM configured to create runtime meta data for file system logical blocks for a nested file system partition;
locate core system protocol services;
remap the core system protocol services to OEM-provided drivers; and
create meta data with offset and file read or write interface services.

9. An information handling system, comprising:
a central processing unit (CPU);
a system memory accessible to the (CPU), including processor executable instructions, wherein the processor executable instructions include one or more secure platform modules (SPMs), wherein the one or more SPMs include:
a first SPM comprising an indicator of attack (IOA) driver configured to perform operations including:
responsive to detecting either a runtime module or a preboot module attempting to locate a file system protocol, authenticating the caller;
responsive to successfully authenticating the module as a trusted driver, granting access to OEM meta data and a file system handle; and
responsive to determining that the module is a runtime application or a UEFI shell application, denying access to the OEM meta data and file system handle.

10. The information handling system of claim 9, wherein the one or more SPMs include:
a second SPM configured to perform secured transition band operations, wherein the secured transition band operations include:
validating and authenticating UEFI core registration for PHY Protocol Interface (PPI) or protocol interface callback services; and
validating a device path of a data access call using UEFI device path protocol.

11. The information handling system of claim 10, wherein said validating of the device path includes:
parsing a device path of the caller; and
determining whether the caller is from preboot, PEI, DXE, or SMM drivers.
de BIOS modules.

12. The information handling system of claim 10, wherein the SPMs include a third SPM comprising a secured GUID data method configured to:
create a GUID based mapping table for unique identifier for PPI or protocol services in pre boot;
store the identifiers to OEM specific declaration files;
remap UEFI identifiers for different PPI or protocol to OEM-unique identifiers, which are exposed to OEM drivers;
responsive to any other PEI or runtime drivers attempting to access core interfaces, passing through OEM authentication layer and providing vulnerable free and protected data access.

13. The information handling system of claim 12, wherein the SPMs include a fourth SPM configured to create runtime meta data for file system logical blocks for a nested file system partition;
locate core system protocol services;
remap the core system protocol services to OEM-provided drivers; and
create meta data with offset and file read or write interface services.

14. The information handling system of claim 9, wherein the SPMs include a third SPM comprising a secured GUID data method configured to:
create a GUID based mapping table for unique identifier for PPI or protocol services in pre boot;
store the identifiers to OEM specific declaration files;
remap UEFI identifiers for different PPI or protocol to OEM-unique identifiers, which are exposed to OEM drivers;
responsive to any other PEI or runtime drivers attempting to access core interfaces, passing through OEM authentication layer and providing vulnerable free and protected data access.

15. The information handling system of claim 14, wherein the SPMs include a fourth SPM configured to create runtime meta data for file system logical blocks for a nested file system partition;
locate core system protocol services;
remap the core system protocol services to OEM-provided drivers; and
create meta data with offset and file read or write interface services.

16. The information handling system of claim 9, wherein the SPMs include a fourth SPM configured to create runtime meta data for file system logical blocks for a nested file system partition;
locate core system protocol services;
remap the core system protocol services to OEM-provided drivers; and
create meta data with offset and file read or write interface services.
